(19) United States
(12) Patent Application Publication
(10) Pub. No.: US 2025/0223941 A1
(43) Pub. Date: Jul. 10, 2025

(54) POWER GENERATION APPARATUS USING GAS BUOYANCY

(71) Applicant: Sungsik KIM, Gwangmyeong-si (KR)

(72) Inventor: Sungsik KIM, Gwangmyeong-si (KR)

(21) Appl. No.: 18/853,781

(22) PCT Filed: Mar. 23, 2023
(86) PCT No.: PCT/KR2023/003866

§ 371 Date: Oct. 3, 2024

(30) Foreign Application Priority Data
Apr. 6, 2022 (KR) 10-2022-0042964

(51) Int. Cl. F03B 17/02; F03B 11/00

(52) U.S. Cl. CPC F03B 17/02; F03B 11/002

(57) ABSTRACT

The present invention relates to a power generation apparatus using gas buoyancy. According to an embodiment of the present invention, disclosed is a power generation apparatus using gas buoyancy configured such that a gas discharge pipe that receives gas through an inlet provided adjacent to the central axis of an impeller and discharges the gas through an outlet provided in the space between a plurality of blades is installed so as to correspond to the space between the plurality of blades, and the impeller and a rotary shaft are rotated on the basis of the buoyancy generated by the gas discharged through the gas discharge pipe.

### TECHNICAL FIELD

The present invention relates to a power generation apparatus using gas buoyancy, and more particularly, to a power generation apparatus using gas buoyancy, which is configured such that a gas discharge pipe configured to receive gas through an inlet provided at a position adjacent to a central axis of an impeller and discharge the gas through an outlet provided in a space between a plurality of blades is installed to correspond to the space between the blades, and the impeller and a rotary shaft are rotated based on buoyancy generated by the gas discharged through the gas discharge pipe.

### BACKGROUND

Apparatuses configured to generate power by using buoyancy of gas such as air have been proposed.

As one example of the related art, Japanese Unexamined Patent Publication No. 52-119735 (Oct. 7, 1977) relates to a power generation apparatus using air buoyancy, and proposes a configuration in which one rotary shaft is disposed on a bottom portion of a water tank, two rotary shafts are arranged in parallel on an upper side of a water surface, sprocket wheels are installed on the rotary shafts, respectively, to rotate a chain, a plurality of buckets are installed at intervals on the chain, and air is injected to the buckets that have moved to a lower side through a nozzle installed on the bottom portion of the water tank, so that buoyancy is generated to provide rotational driving force.

As another example of the related art, Japanese Unexamined Patent Publication No. 11-324891 (Nov. 26, 1999) relates to a rotational driving apparatus using air bubbles, and proposes rotation blades that are axially an apparatus in which supported in an approximately horizontal direction by a side portion of a liquid charging tank having an air inlet at a lower portion thereof and having an air outlet at an upper portion thereof are installed in a plurality of stages in a vertical direction, and the rotation blade is configured such that a plurality of rotation plates are curved or bent to allow a side of the rotation plate, which collides with ascending bubbles, to be concave, so that rotational driving force is provided by using air bubbles based on interworking of the rotation blades arranged in the stages by a chain or a belt.

As still another example of the related art, Korean Unexamined Patent Publication No. 10-1991-0017069 (Nov. 5, 1991) relates to a power generation apparatus using buoyancy, which proposes an apparatus configuration in which a chain-type belt having an inner surface concave-protruding part is engaged with a driven gear and a driving gear, which are attached to upper and lower portions of a support rod, an umbrella-type cap installed so as to be spreadable and foldable is installed on an outer surface portion of the chain-type belt, and air from an air extrusion port is injected into the umbrella-type cap that has moved to a lower side by rotation of the chain-type belt, so that power is generated by using buoyancy.

As yet another example of the related art, Korean Utility Model Registration No. 20-0230182 (Apr. 30, 2001) relates to a rotational force generation apparatus that repeatedly uses ascending force of air bubbles, which proposes a configuration in which a water tank that is similar to a rectangular parallelepiped or a cylinder is installed upright, a plurality of watermills are installed vertically inside the water tank to transverse a direction in which air bubbles ascend and travel, and the water tank is filled with water so that the air bubbles supplied through an air inlet on a bottom or a side surface of the water tank ascend to rotate the watermills in sequence.

As still yet another example of the related art, Korean Unexamined Patent Publication No. 10-2009-0115904 (Nov. 10, 2009) relates to a buoyancy power generation system by installing an air passage underwater to supply air from a bottom of water, and proposes a system in which an air passage, which is an “air dam”, is installed underwater to form potential energy of air at a bottom of water, a pressure that is higher than a water pressure is formed in the air passage to supply the air underwater through a check valve so as to implement the potential energy as buoyancy, and the generated buoyancy is stored in an air pocket attached to a power belt to rotate a turbine so that electricity is produced.

However, the examples of the related art described above have a structure in which air for generating buoyancy is provided to the rotation blade (or the bucket, the watermill, the air pocket) by using an air injection device installed on a lower side of a water storage tank, so that there is a limitation that some of the air leaks out of the rotation blade so as to reduce power generation efficiency.

### DISCLOSURE

### Technical Problem

The present invention has been devised in consideration of the problems described above, and an object of the present invention is to provide a power generation apparatus using gas buoyancy, which is configured such that a gas discharge pipe configured to receive gas through an inlet provided at a position adjacent to a central axis of an impeller and discharge the gas through an outlet provided in a space between a plurality of blades is installed to correspond to the space between the blades, and the impeller and a rotary shaft are rotated based on buoyancy generated by the gas discharged through the gas discharge pipe.

### Technical Solution

To achieve the object described above, according to one aspect of the present invention, there is disclosed a power generation apparatus using gas buoyancy, the power generation apparatus including: an impeller including a plurality of blades arranged at intervals and installed outward about a central axis, and including a gas discharge pipe configured to receive gas through an inlet provided at a position adjacent to the central axis and discharge the gas through an outlet provided in a space between the blades and provided to correspond to the space between the blades; a rotary shaft disposed along the central axis of the impeller and installed integrally with the impeller to transmit rotational force generated when the impeller rotates to an outside; a support part configured to rotatably support the rotary shaft; and a gas transmission part configured to receive the gas from the outside and transmit the gas to an inlet of at least one gas discharge pipe located on a lower side based on the central axis of the impeller through a gas transmission port, wherein the gas is discharged through the gas discharge pipe in a space between one or more of the blades located on the lower side based on the central axis of the impeller submerged in a liquid, and the impeller and the rotary shaft are rotated based on buoyancy generated by the discharged gas.

Preferably, the gas transmission part may be formed in the support part.

Preferably, the support part may include a support rod installed on one side of the impeller and configured to support a load of the impeller, the inlet of the gas discharge pipe may be formed on a side surface of the impeller, and the gas transmission port may be formed on a side surface of the support part, which faces the side surface of the impeller.

Preferably, the support part may include an inner rotary shaft having a hollow shape and inserted inside the rotary shaft to penetrate the rotary shaft so as to rotate relative to the rotary shaft along the central axis of the impeller, the inlet of the gas discharge pipe may be formed through the rotary shaft, and the gas transmission port may be formed through a lower side of the inner rotary shaft having the hollow shape and constituting the support part.

Preferably, the gas transmission port may have an asymmetrical hole shape extending to one side in a rotation direction of the impeller based on a direct downward direction of the impeller.

Preferably, the impeller may include: a central body part to which the rotary shaft is coupled and having a cylindrical shape with a predetermined width; an outer body part installed to surround an outer side of the central body part, having a cylindrical shape with a predetermined width, and including a plurality of gas discharge regions formed at intervals along an outer periphery of the cylindrical shape of the outer body part so that the gas discharged through the space between the blades is discharged to an upper portion of the liquid by the buoyancy; the blades arranged at the intervals along an outer periphery of the cylindrical shape of the central body part, in which one end portion of the blade, which is close to the central axis of the impeller, is coupled to the central body part; and the gas discharge pipe installed on an inner side of the central body part.

Preferably, each of the blades may be configured such that the one end portion of the blade, which is close to the central axis of the impeller, is coupled to the outer periphery of the cylindrical shape of the central body part so as to be rotatable about a rotation part.

Preferably, each of the blades may be configured such that a rotation angle varies according to whether the gas is introduced into or discharged from a space between rear surfaces of the blades.

Preferably, a plurality of latching parts may be formed at intervals along the outer periphery of the cylindrical shape of the outer body part, and each of the blades may be configured such that an opposite end portion of the blade, which is far from the central axis of the impeller, is latched to or released from each of the latching parts according to a variation in a rotation angle about the rotation part.

Preferably, a plurality of latching parts may be formed at intervals along the outer periphery of the cylindrical shape of the outer body part, and each of the blades may be configured such that: an opposite end portion of the blade, which is far from the central axis of the impeller, is latched to the latching part when the gas is introduced into a space between rear surfaces of the blades; and the opposite end portion of the blade, which is far from the central axis of the impeller, is released from the latching part when the gas is discharged from the space between the rear surfaces of the blades.

Preferably, each of the blades may have a middle portion having a front surface shape protruding and curved in a rotation direction of the impeller.

Preferably, at least two impellers may be installed in parallel on one rotary shaft, and a gas transmission part configured to transmit the gas to an inlet of at least one gas discharge pipe located on the lower side based on a central axis of each of the impellers may be provided for each of the impellers.

Preferably, according to the present invention, the gas discharged through the space between the blades through a plurality of gas discharge regions formed at intervals along an outer periphery of the impeller may be discharged to an upper portion of the liquid by the buoyancy.

Preferably, each of the blades may be configured such that one end portion of the blade, which is close to the central axis of the impeller, is coupled so as to be rotatable about a rotation part, and a rotation angle varies according to whether the gas is introduced into or discharged from a space between rear surfaces of the blades.

Preferably, each of the blades may be configured such that an opposite end portion of the blade, which is far from the central axis of the impeller, is latched to or released from each of latching parts formed at intervals along the outer periphery of the impeller according to a variation in the rotation angle about the rotation part.

### Advantageous Effects

According to the present invention described above, gas from a gas discharge pipe may be discharged through an outlet provided in a space between a plurality of blades of an impeller, so that the gas discharged through the gas discharge pipe can be accurately supplied to the space between the blades, and thus the impeller can rotate efficiently.

### DESCRIPTION OF DRAWINGS

FIG. 1 is a schematic view showing a front side of a power generation apparatus using gas buoyancy according to an embodiment of the present invention.

FIG. 2 is a schematic view for describing a gas transmission port of the power generation apparatus using the gas buoyancy according to the embodiment of the present invention.

FIG. 3 is a schematic view showing a side section of the power generation apparatus using the gas buoyancy according to the embodiment of the present invention.

FIG. 4 is a schematic view showing a side section of a power generation apparatus using gas buoyancy according to another embodiment of the present invention.

FIG. 5 is a schematic view for describing a gas transmission port of the power generation apparatus using the gas buoyancy according to another embodiment of the present invention.

FIG. 6 is a schematic view showing a side section of a power generation apparatus using gas buoyancy according to still another embodiment of the present invention.

FIG. 7 is a schematic view showing a side section of a power generation apparatus using gas buoyancy according to yet another embodiment of the present invention.

### BEST MODE

The present invention may be implemented in various other forms without departing from the technical idea or main characteristics thereof. Therefore, embodiments of the present invention are merely examples in all respects and should not be construed as limiting.

The terms such as “first” and “second” are used merely for the purpose of distinguishing one element from another element. For example, a first element may be termed as a second element, and similarly, a second element may also be termed as a first element without departing from the scope of the present invention.

When one element is described as being “connected” or “accessed” to another element, it shall be construed as being connected or accessed to the other element directly, but also as possibly having another element in between.

Unless the context explicitly indicates otherwise, an expression in a singular form used in the present disclosure includes a meaning of a plural form. In the present disclosure, the term such as “comprise”, “include”, or “have” is intended to express the presence of elements or combinations thereof described herein, and shall not be construed to preclude any possibility of the presence or addition of other elements or characteristics.

Hereinafter, an exemplary embodiment of the present invention will be described in detail with reference to the accompanying drawings.

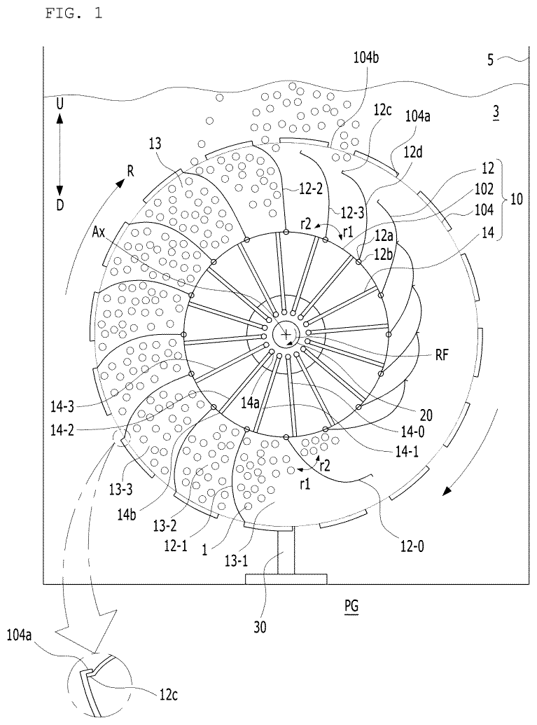

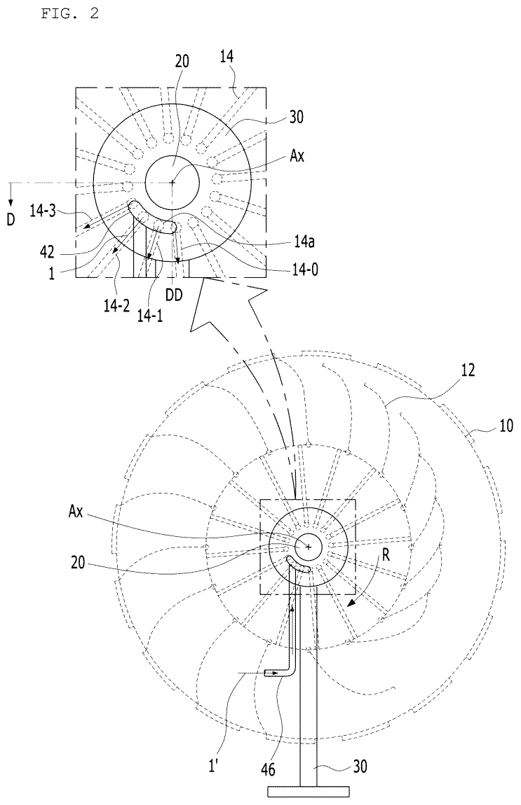

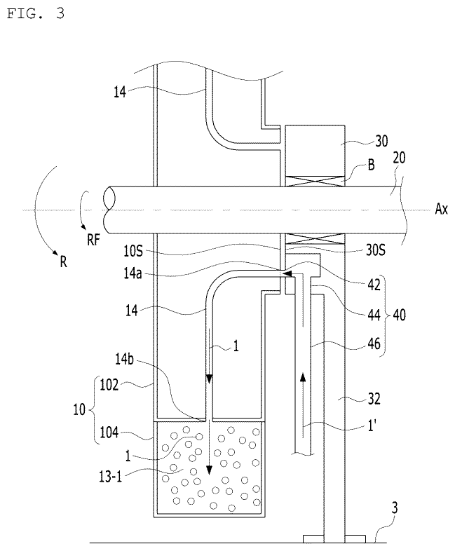

FIG. 1 is a schematic view showing a front side of a power generation apparatus using gas buoyancy according to an embodiment of the present invention, FIG. 2 is a schematic view for describing a gas transmission port of the power generation apparatus using the gas buoyancy according to the embodiment of the present invention, and FIG. 3 is a schematic view showing a side section of the power generation apparatus using the gas buoyancy according to the embodiment of the present invention.

According to the present embodiment, a power generation apparatus PG using gas buoyancy may be configured such that a gas discharge pipe 14 configured to receive gas 1 through an inlet 14a provided at a position adjacent to a central axis Ax of an impeller 10 and discharge the gas 1 through an outlet 14b provided in a space 13 between a plurality of blades 12 is installed to correspond to the space 13 between the blades 12, and the impeller 10 and a rotary shaft 20 are rotated based on buoyancy generated by the gas 1 discharged through the gas discharge pipe 14.

In more detail, the impeller 10 may include a plurality of blades 12 arranged at intervals and installed outward about a central axis Ax, and may include a gas discharge pipe 14 configured to receive gas 1 through an inlet 14a provided at a position adjacent to the central axis Ax and discharge the gas 1 through an outlet 14b provided in a space 13 between the blades 12 and provided to correspond to the space 13 between the blades 12.

The rotary shaft 20 may be disposed along the central axis Ax of the impeller 10 and installed integrally with the impeller 10 to transmit rotational force RF generated when the impeller 10 rotates to an outside.

A support part 30 may rotatably support the rotary shaft 20. Although the rotary shaft 20 has been illustrated in FIG. 3 as being supported only on a rear side of the impeller 10, the rotary shaft 20 may be supported on a front side and/or a rear side of the impeller 10.

A gas transmission part 40 may receive the gas 1 from the outside and transmit the gas 1 to an inlet 14a of at least one gas discharge pipe 14 located on a lower (D) side based on the central axis Ax of the impeller 10 through a gas transmission port 42 (see FIG. 2).

According to the power generation apparatus PG using the gas buoyancy of the present embodiment, through the above configuration, the gas 1 may be discharged through the gas discharge pipe 14 in a space 13 between one or more of the blades 12 located on the lower (D) side based on the central axis Ax of the impeller 10 submerged in a liquid 3, and the impeller 10 and the rotary shaft 20 may be rotated based on buoyancy generated by the discharged gas 1. For example, a type of the liquid 3 may preferably be water without being limited, and the liquid 3 may be stored inside a liquid storage container 5 having various shapes. A type of the gas 1 may preferably be air without being limited.

For example, each of elements of the power generation apparatus PG using the gas buoyancy according to the present embodiment may be formed of a metal material or a synthetic resin material.

The detailed configuration of the power generation apparatus PG using the gas buoyancy according to the present embodiment will be described.

Preferably, the gas transmission part 40 may be formed in the support part 30. For example, the gas transmission part 40 may include a gas supply pipe 46 configured to receive the gas 1 from the outside, a gas distribution part 44 formed inside or outside the support part 30, and a gas transmission port 42 formed inside or outside the support part 30 and configured to transmit the gas 1 distributed from the gas distribution part 44 to the inlet 14a of the gas discharge pipe 14 of the impeller 10. FIG. 3 illustrates a case in which the gas distribution part 44 is formed inside the support part 30, and the gas transmission port 42 is formed through one side of the support part 30.

For example, the support part 30 may include a support rod 32 installed on one side of the impeller 10 and configured to support a load of the impeller 10. The support rod 32 may rotatably support the rotary shaft 20 integrally coupled to the impeller 10 with a bearing B interposed therebetween. In the case of FIG. 3, the support rod 32 may support loads of the impeller 10 and the rotary shaft 20 based on a bottom surface of the liquid storage container 5.

In addition, the inlet 14a of the gas discharge pipe 14 may be formed on a side surface 10s of the impeller 10.

In addition, the gas transmission port 42 may be formed on a side surface 30s of the support part 30, which faces the side surface 10s of the impeller 10, and may transmit the gas 1 through a region communicating with the inlet 14a of the gas discharge pipe 14.

Preferably, the gas transmission port 42 may have an asymmetrical hole shape extending to one side in a rotation direction R of the impeller 10 based on a direct downward direction DD of the impeller 10 (see FIG. 2).

Preferably, the impeller 10 may include a central body part 102, an outer body part 104, a plurality of blades 12, and a gas discharge pipe 14.

The central body part 102 to which the rotary shaft 20 is coupled may have a cylindrical shape with a predetermined width.

The outer body part 104 may be installed to surround an outer side of the central body part 102, may have a cylindrical shape with a predetermined width, and may include a plurality of gas discharge regions 104b formed at intervals along an outer periphery of the cylindrical shape of the outer body part 104 so that the gas 1 discharged through the space 13 between the blades 12 may be discharged to an upper portion U of the liquid 3 by the buoyancy. A space between adjacent gas discharge regions 104b may be closed to prevent the gas 1 from escaping.

The blades 12 may be arranged at the intervals along an outer periphery of the cylindrical shape of the central body part 102, in which one end portion 12a of the blade 12, which is close to the central axis Ax of the impeller 10, may be coupled to the central body part 102. Preferably, the intervals may be constant.

The gas discharge pipe 14 may be installed on an inner side of the central body part 102, and may have a curved portion in a middle section to smoothly connect the inlet 14a to the outlet 14b.

Preferably, each of the blades 12 may be configured such that the one end portion 12a of the blade 12, which is close to the central axis Ax of the impeller 10, is coupled to the outer periphery of the cylindrical shape of the central body part 102 so as to be rotatable about a rotation part 12b.

Each of the blades 12 may be configured such that a rotation angle (r1-r2) about the rotation part 12b varies according to whether the gas 1 is introduced into or discharged from a space 13 between rear surfaces of the blades 12.

A plurality of latching parts 104a may be formed at intervals along the outer periphery of the cylindrical shape of the outer body part 104. For example, the latching part 104a may be configured in the form of a latching sill formed on an inner surface of the cylindrical shape of the outer body part 104, but is not limited thereto.

In addition, each of the blades 12 may be configured such that an opposite end portion 12c of the blade 12, which is far from the central axis Ax of the impeller 10, may be latched to or released from each of the latching parts 104a according to a variation in a rotation angle (r1-r2) about the rotation part 12b. To this end, the opposite end portion 12c of each of the blades 12 may have a portion bent or protruding to a predetermined length so as to be latched to or released from the latching part 104a.

Through the above configuration, each of the blades 12 may be configured such that: the opposite end portion 12c of the blade 12, which is far from the central axis Ax of the impeller 10, rotates in a direction r1 so as to be latched to the latching part 104a when the gas 1 is introduced into a space 13 between rear surfaces of the blades 12; and the opposite end portion 12c of the blade 12, which is far from the central axis Ax of the impeller 10, rotates in a direction r2 so as to be released from the latching part 104a when the gas 1 is discharged from the space 13 between the rear surfaces of the blades 12.

Preferably, each of the blades 12 may have a middle portion 12d having a front surface shape protruding and curved in a rotation direction R of the impeller 10. Through the curved shape, the impeller 10 and the blades 12 may rotate smoothly.

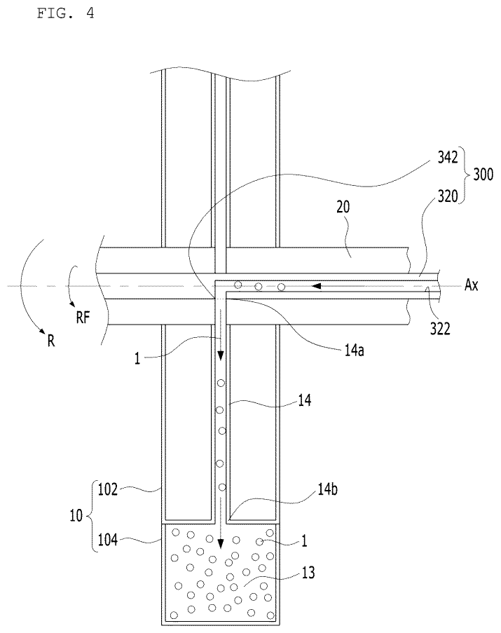

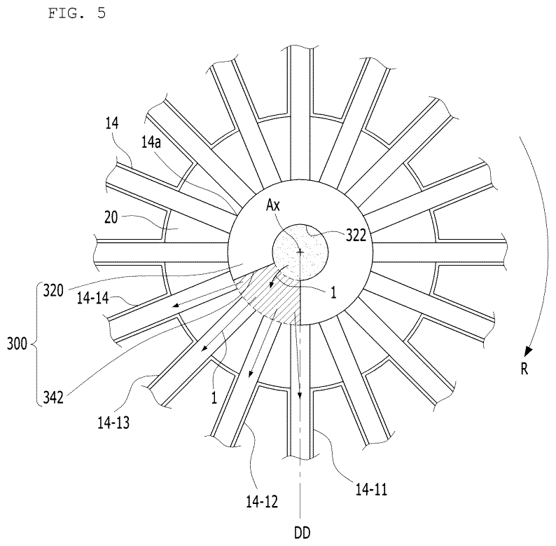

FIG. 4 is a schematic view showing a side section of a power generation apparatus using gas buoyancy according to another embodiment of the present invention, and FIG. 5 is a schematic view for describing a gas transmission port of the power generation apparatus using the gas buoyancy according to another embodiment of the present invention.

According to the present embodiment, the support part 300 may include an inner rotary shaft 320 having a hollow shape and inserted inside the rotary shaft 20 to penetrate the rotary shaft 20 so as to rotate relative to the rotary shaft 20 along the central axis Ax of the impeller 10. For example, one or both ends of the inner rotary shaft 320 may be supported while being fixed onto the support rod. In addition, a flow pipe line 322 through which the gas 1 flows in a shaft length direction may be formed through at least a partial section of a central portion of the inner rotary shaft 320. The inner rotary shaft 320 may provide a function of a fixed shaft configured to supply the gas by using the flow pipe line 322.

According to the present embodiment, the inlet 14a of the gas discharge pipe 14 may be formed through the rotary shaft 20.

According to the present embodiment, the gas transmission port 342 may be formed through a predetermined position on a lower side of the inner rotary shaft 320 having the hollow shape and constituting the support part 300. The position through which the gas transmission port 342 is formed may be a position in which the gas transmission port 342 may communicate with some of inlets 14a of a plurality of gas discharge pipes 14 to form a flow path of the gas 1.

In addition, the gas transmission port 342 may have an asymmetrical hole shape extending to one side in a rotation direction R of the impeller 10 based on a direct downward direction DD of the impeller 10 (see FIG. 5).

The flow pipe line 322 and the gas transmission port 342 may constitute the gas transmission part 40 according to the present embodiment. To this end, the flow pipe line 322 may receive the gas 1 from the outside through the gas supply pipe 46 having a shape that is identical or similar to the shape illustrated in FIG. 3.

Operation states of the power generation apparatus PG using the gas buoyancy according to the present embodiment will be described with reference to FIGS. 1 to 3.

The impeller 10 may be installed in the container 5 based on the support part 30, and the liquid 3 may be stored in the container 5 to allow the impeller 10 to be submerged in the liquid 3, so that the power generation apparatus PG may be set. For example, water may be used as the liquid 3, but is not limited thereto.

The gas transmission part 40 may receive gas 1′ from the outside and transmit the gas 1 to the inlet 14a of at least one gas discharge pipe 14 located on the lower (D) side based on the central axis Ax of the impeller 10 through the gas transmission port 42.

For example, as an external source configured to supply the gas 1′ from the outside, high-pressure gas generated from utility facilities of various industrial facilities may be used, or high-pressure gas generated naturally may be used. For example, the high-pressure gas generated from the utility facilities of the various industrial facilities may be various waste gas generated as by-products from the industrial facilities (factories), and an example of such high-pressure gas includes by-product gas discharged as a by-product from a steel mill, an oil refinery, a chemical plant, or the like. For example, the high-pressure gas generated naturally may be volcanic gas or hot spring gas generated in a hot spring region near a volcano. For example, the volcanic gas may refer to a volatile component in magma erupted on a ground surface, and the gas may be generated naturally from a crater, a fumarole, a hot spring vent, or the like in volcanoes that do not emit fire. The power generation apparatus PG using the gas buoyancy according to the present embodiment may provide a function of an energy regeneration device by using such an external source.

As another example, the power generation apparatus PG according to the present embodiment may be installed and used in a place where it is difficult to install an electric motor due to environmental reasons, and in this case, the external source configured to supply the gas 1′ from the outside may be a compressor configured to supply the gas 1′ through the gas supply pipe 46. The power generation apparatus PG using the gas buoyancy according to the present embodiment may be installed instead of an electric motor in a site where there is a risk of fire/explosion due to electricity so as to safely generate and provide power.

In the case of FIG. 2, since a region of inlets 14a of gas discharge pipes 14-0, 14-1, 14-2, and 14-3 among the gas discharge pipes 14 located on the lower (D) side based on the central axis Ax of the impeller 10 overlaps a region of the gas transmission port 42, the gas 1 may be supplied from the gas transmission port 42 to the gas discharge pipes 14-0, 14-1, 14-2, and 14-3.

In order to enable smooth rotation of the impeller 10, as illustrated in FIG. 2, the gas transmission port 42 may have an asymmetrical hole shape extending to one side in the rotation direction R of the impeller 10 based on the direct downward direction DD of the impeller 10. In the case of FIG. 2, the gas transmission port 42 may have an asymmetrical hole shape extending in an arc shape approximately from a 6 o'clock direction to an 8 o'clock direction.

Referring to FIG. 1, the gas 1 supplied to the gas discharge pipes 14-0, 14-1, 14-2, and 14-3 may supply the gas 1 to the space 13 between the blades 12 connected to each outlet 14b, so that the impeller 10 may obtain rotational force to rotate in the direction R by the buoyancy of the gas 1 supplied to the space 13 between four blades 12 located approximately from the 6 o'clock direction to the 8 o'clock direction.

When the impeller 10 rotates in the direction R about the rotary shaft 20, the gas discharge pipes 14-0, 14-1, 14-2, and 14-3, which constitute a portion of the impeller 10, may also rotate in the direction R, and may be released from a communication state with the gas transmission port 42 in an order of the gas discharge pipe 14-3→the gas discharge pipe 14-2→the gas discharge pipe 14-1, and the gas discharge pipe 14-0 by the rotation in the direction R. In addition, a gas discharge pipe located on a rear side of the gas discharge pipe 14-0 (on a right side of FIG. 1) and other gas discharge pipes 14 located further on a rear side of the gas discharge pipe may sequentially communicate with the gas transmission port 42 to receive the gas 1.

Through the above process, the impeller 10 may continuously rotate in the direction R, and the rotational force RF may be transmitted to the outside through the rotary shaft 20 installed integrally with the impeller 10.

During a process of rotating the impeller 10 in the direction R, the gas 1 may be discharged to the upper portion U of the liquid 3 by the buoyancy through the gas discharge region 104b from the space 13 between the blades 12, which has reached a position of about an 11 o'clock direction in FIG. 1.

Through the above gas supply/discharge process, the impeller 10 may rotate in the direction R while the gas 1 is discharged from the space 13 between the blades 12 at a rotation position corresponding to a 12 o'clock direction→the 6 o'clock direction of FIG. 1 (a right section of the impeller in FIG. 1), and the impeller 10 may rotate in the direction R while the gas 1 is introduced into the space 13 between the blades 12 at a rotation position corresponding to the 6 o'clock direction→the 12 o'clock direction of FIG. 1 (a left section of the impeller in FIG. 1).

In the rotational driving process described above, a driving device such as a motor may be connected to one side of the rotary shaft 20 to temporarily assist initial driving until the impeller 10 reaches a continuous rotation state in the direction R so that initial rotation of the impeller 10 may be smoothly performed.

The rotational force generated as a result of the rotation described above may be supplied to various devices requiring rotational force, including, for example, a power generator.

Meanwhile, in the rotational driving process described above, the rotation angle (r1-r2) of each of the blades 12 may vary for the smooth rotation of the impeller 10.

In other words, since the impeller 10 rotates in the direction R while the gas 1 is discharged from the space 13 between the blades 12 at the rotation position corresponding to the 12 o'clock direction→the 6 o'clock direction of FIG. 1 (the right section of the impeller in FIG. 1), in this section, when the blade 12 rotates in the direction r2 about the rotation part 12b to approach or make contact with the cylindrical shape of the central body part 102, a rotation resistance of the liquid 3 may be reduced, which may be advantageous for the rotation of the impeller 10.

On the contrary, since the impeller 10 rotates in the direction R while the gas 1 is introduced into the space 13 between the blades 12 at the rotation position corresponding to the 6 o'clock direction→the 12 o'clock direction of FIG. 1 (the left section of the impeller in FIG. 1), in this section, when the blade 12 rotates in the direction r1 about the rotation part 12b so as to be spaced apart from the cylindrical shape of the central body part 102 as much as possible so that the gas 1 may be collected in the space 13 between the blades 12 as much as possible, the buoyancy may be increased, which may be advantageous in increasing the rotational force.

To this end, each of the blades 12 may be configured such that the rotation angle (r1-r2) varies according to whether the gas 1 is introduced into or discharged from the space 13 between the rear surfaces of the blades 12.

Referring to FIG. 1, each of the blades 12 may rotate while approaching or making contact with the central body part 102 at the rotation position corresponding to the 12 o'clock direction→the 6 o'clock direction of FIG. 1 (the right section of the impeller in FIG. 1), and may be gradually spaced apart from the central body part 102 by a weight of the blade and the supply of the gas 1 at about a position of a blade 12-0 of FIG. 1.

Thereafter, when the gas 1 supplied to the gas discharge pipes 14-0, 14-1, 14-2, and 14-3 supplies the gas 1 to the space 13 between the blades 12 connected to each outlet 14b, the blade 12 may rotate in the direction r1 about the rotation part 12b from about a position of a space 13-1 between the blades 12 due to the buoyancy of the gas 1 so as to be spaced apart from the cylindrical shape of the central body part 102 as much as possible so that the gas 1 may be collected in the space 13 between the blades 12 as much as possible. In this process, the opposite end portion 12c of the blade 12, which is far from the central axis Ax of the impeller 10, may be latched to the latching part 104a corresponding to the position.

Thereafter, when the space 13 between the blades 12, which has collected the gas 1 by the rotation of the impeller 10 in the direction R, reaches the position of about the 11 o'clock direction in FIG. 1, the gas 1 may be discharged to the upper portion U of the liquid 3 by the buoyancy through the gas discharge region 104b from the space 13 between the blades 12.

Thereafter, the blade 12 may naturally rotate in the direction r2 due to the liquid resistance from about the 12 o'clock direction in FIG. 1 so as to approach or make contact with the central body part 102.

In this process, the opposite end portion 12c of the blade 12, which is far from the central axis Ax of the impeller 10, may be released from the latching part 104a corresponding to the position.

Operation states of the power generation apparatus PG using the gas buoyancy according to the present embodiment will be described with reference to FIGS. 4 and 5.

In the case of the embodiment of FIGS. 4 and 5, a basic operation is identical or similar to the basic operation of the embodiment of FIGS. 1 to 3.

However, in the case of the embodiment of FIGS. 4 and 5, the gas transmission port 342 may be formed through the lower side of the inner rotary shaft 320 having the hollow shape and constituting the support part 300, and referring to FIG. 5, the gas transmission port 342 may have an asymmetrical hole shape extending in an arc shape approximately from the 6 o'clock direction to the 8 o'clock direction in the rotation direction R of the impeller 10 based on the direct downward direction DD of the impeller 10.

Referring to FIG. 5, since a region of inlets 14a of gas discharge pipes 14-11, 14-12, 14-13, and 14-14 among the gas discharge pipes 14 located on the lower (D) side based on the central axis Ax of the impeller 10 communicates with a region of the gas transmission port 342, the gas 1 may be supplied from the gas transmission port 342 to the gas discharge pipes 14-11, 14-12, 14-13, and 14-14.

The gas 1 supplied to the gas discharge pipes 14-11, 14-12, 14-13, and 14-14 may supply the gas 1 to the space 13 between the blades 12 connected to each outlet 14b, so that the impeller 10 may obtain rotational force to rotate in the direction R by the buoyancy of the gas 1 supplied to the space 13 between four blades 12 (three blades depending on a rotation state) located approximately from the 6 o'clock direction to the 8 o'clock direction.

When the impeller 10 rotates in the direction R about the rotary shaft 20, the gas discharge pipes 14-11, 14-12, 14-13, and 14-14, which constitute a portion of the impeller 10, may also rotate in the direction R, and may be released from a communication state with the gas transmission port 342 in an order of the gas discharge pipe 14-14→the gas discharge pipe 14-13→the gas discharge pipe 14-12→the gas discharge pipe 14-11 by the rotation in the direction R. In addition, a gas discharge pipe located on a rear side of the gas discharge pipe 14-11 (on a right side of FIG. 5) and other gas discharge pipes 14 located further on a rear side of the gas discharge pipe may sequentially communicate with the gas transmission port 342 to 10 receive the gas 1.

Through the above process, the impeller 10 may continuously rotate in the direction R, and the rotational force RF may be transmitted to the outside through the rotary shaft 20 installed integrally with the impeller 10.

Other operations are identical or similar to the operations of the embodiment of FIGS. 1 to 3, so that redundant descriptions will be omitted.

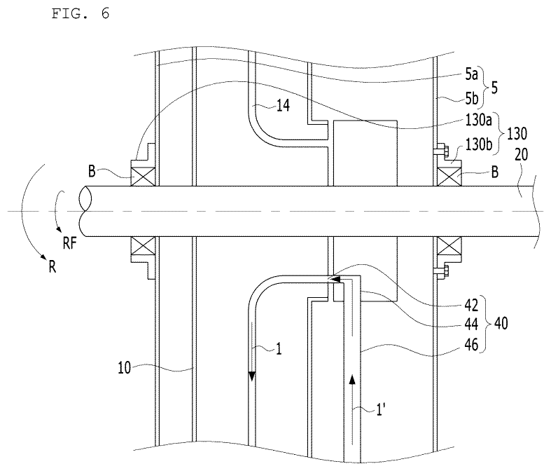

FIG. 6 is a schematic view showing a side section of a power generation apparatus using gas buoyancy according to still another embodiment of the present invention.

A support part 130 according to the present embodiment may be installed in the container 5 that allows the impeller 10 to be submerged in the liquid 3.

In the case of the present embodiment, both sides of the rotary shaft 20 may be rotatably supported through bearing support parts 130a and 130b and bearings B installed on both side surfaces 5a and 5b of the container 5.

The gas transmission part 40 according to the present embodiment may be installed inside the container 5, and may be installed as a separate element from the support part 130. For example, the impeller 10 may rotate integrally with the rotary shaft 20, and the gas transmission part 40 may be fixedly installed inside the container 5 with a structure that is not affected by the rotation of the rotary shaft 20.

For example, the gas transmission part 40 according to the present embodiment may include a gas supply pipe 46 configured to receive the gas 1′ from the outside, a gas distribution part 44 formed inside or outside a main body of the gas transmission part 40, and a gas transmission port 42 formed inside or outside the main body of the gas transmission part 40 to transmit the gas 1 distributed from the gas distribution part 44 to the inlet 14a of the gas discharge pipe 14 of the impeller 10. FIG. 6 illustrates a case in which the gas distribution part 44 is formed inside the main body of the gas transmission part 40, and the gas transmission port 42 is formed through one side of the main body of the gas transmission part 40.

The inlet 14a of the gas discharge pipe 14 of the impeller 10 may be formed on the side surface 10s of the impeller 10 (see FIG. 3). In addition, the gas transmission port 42 may be formed on a side surface of the main body of the gas transmission part 40, which faces the side surface 10s of the impeller 10, and may transmit the gas 1 through a region communicating with the inlet 14a of the gas discharge pipe 14.

FIG. 6 illustrates that the bearing support parts 130a and 130b and the bearings B are installed on outer sides of the both side surfaces 5a and 5b of the container 5, respectively, and the both sides of the rotary shaft 20 are installed to pass through the both side surfaces of the container 5. In this case, although not shown, a sealing device may be installed on the both side surfaces 5a and 5b of the container 5 to prevent a leak of the liquid 3.

As another example, the bearing support parts 130a and 130b and the bearings B may be installed on inner sides of the both side surfaces 5a and 5b, respectively, and the both sides of the rotary shaft 20 may be installed without passing through the both side surfaces of the container 5. In this case, a separate power transmission mechanism (e.g., a gear mechanism or a belt-pulley mechanism) configured to output power of the rotary shaft 20 from an inside of the container 5 to the outside may be installed.

As still another example, one side of the rotary shaft 20 may be installed without passing through the side surface of the container 5, and an opposite side of the rotary shaft 20 may be installed to pass through the side surface of the container 5. In this case, one set of the bearing support parts 130a and 130b and the bearings B may be installed on an inner side of one side surface 5a of the container, and an opposite set of the bearing support parts 130a and 130b and the bearings B may be installed on an outer side of an opposite side surface 5b of the container.

As yet another example, the bearing support parts 130a and 130b and the bearings B may be installed on both support rods (not shown) separately installed on the outer sides of the both side surfaces 5a and 5b of the container 5, and the both sides of the rotary shaft 20 may be installed on the both support rods to pass through the both side surfaces of the container 5, respectively. In this case, although not shown, a sealing device may be installed on the both side surfaces 5a and 5b of the container 5 to prevent a leak of the liquid 3.

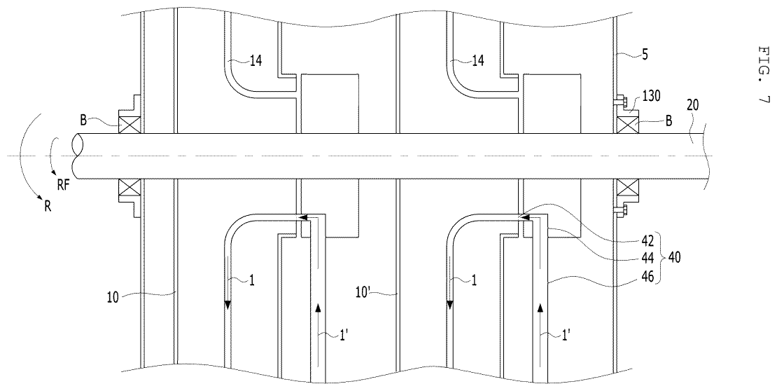

FIG. 7 is a schematic view showing a side section of a power generation apparatus using gas buoyancy according to yet another embodiment of the present invention.

The power generation apparatus according to the present embodiment may include at least two impellers 10 so that greater power may be generated with one apparatus.

To this end, the power generation apparatus according to the present embodiment may be configured such that at least two impellers 10 are installed in parallel on one rotary shaft 20, and a gas transmission part 40 configured to transmit the gas 1 to an inlet 14a of at least one gas discharge pipe 14 located on the lower side based on a central axis Ax of each of the impellers 10 is provided for each of the impellers 10.

Although FIG. 7 illustrates a case in which at least two impellers 10 are provided, at least three impellers 10 may be provided.

Configurations of the gas transmission part 40 and the support part may be variously modified similarly to the embodiment described above, and redundant descriptions thereof will be omitted.

Although exemplary embodiments of the present invention have been described with reference to the accompanying drawings, it will be apparent to those skilled in the art that many various and obvious modifications can be made from such descriptions without departing from the scope of the present invention. Therefore, the scope of the present invention shall be interpreted by the claims described to encompass such many modifications.

1. A power generation apparatus using gas buoyancy, the power generation apparatus comprising:
an impeller including a plurality of blades arranged at intervals and installed outward about a central axis, and including a gas discharge pipe configured to receive gas through an inlet provided at a position adjacent to the central axis and discharge the gas through an outlet provided in a space between the blades and provided to correspond to the space between the blades;
a rotary shaft disposed along the central axis of the impeller and installed integrally with the impeller to transmit rotational force generated when the impeller rotates to an outside;
a support part configured to rotatably support the rotary shaft; and
a gas transmission part configured to receive the gas from the outside and transmit the gas to an inlet of at least one gas discharge pipe located on a lower side based on the central axis of the impeller through a gas transmission port,
wherein the gas is discharged through the gas discharge pipe in a space between one or more of the blades located on the lower side based on the central axis of the impeller submerged in a liquid, and the impeller and the rotary shaft are rotated based on buoyancy generated by the discharged gas.

2. The power generation apparatus of claim 1, wherein the gas transmission part is formed in the support part.

3. The power generation apparatus of claim 2, wherein the support part includes a support rod installed on one side of the impeller and configured to support a load of the impeller,
the inlet of the gas discharge pipe is formed on a side surface of the impeller, and
the gas transmission port is formed on a side surface of the support part, which faces the side surface of the impeller.

4. The power generation apparatus of claim 2, wherein the support part includes an inner rotary shaft having a hollow shape and inserted inside the rotary shaft to penetrate the rotary shaft so as to rotate relative to the rotary shaft along the central axis of the impeller,
the inlet of the gas discharge pipe is formed through the rotary shaft, and
the gas transmission port is formed through a lower side of the inner rotary shaft having the hollow shape and constituting the support part.

5. The power generation apparatus of claim 1, wherein the gas transmission port has an asymmetrical hole shape extending to one side in a rotation direction of the impeller based on a direct downward direction of the impeller.

6. The power generation apparatus of claim 1, wherein the impeller includes:
a central body part to which the rotary shaft is coupled and having a cylindrical shape with a predetermined width;
an outer body part installed to surround an outer side of the central body part, having a cylindrical shape with a predetermined width, and including a plurality of gas discharge regions formed at intervals along an outer periphery of the cylindrical shape of the outer body part so that the gas discharged through the space between the blades is discharged to an upper portion of the liquid by the buoyancy;
the blades arranged at the intervals along an outer periphery of the cylindrical shape of the central body part, in which one end portion of the blade, which is close to the central axis of the impeller, is coupled to the central body part; and
the gas discharge pipe installed on an inner side of the central body part.

7. The power generation apparatus of claim 6, wherein each of the blades is configured such that the one end portion of the blade, which is close to the central axis of the impeller, is coupled to the outer periphery of the cylindrical shape of the central body part so as to be rotatable about a rotation part.

8. The power generation apparatus of claim 7, wherein each of the blades is configured such that a rotation angle varies according to whether the gas is introduced into or discharged from a space between rear surfaces of the blades.

9. The power generation apparatus of claim 7, wherein a plurality of latching parts are formed at intervals along the outer periphery of the cylindrical shape of the outer body part, and
each of the blades is configured such that an opposite end portion of the blade, which is far from the central axis of the impeller, is latched to or released from each of the latching parts according to a variation in a rotation angle about the rotation part.

10. The power generation apparatus of claim 7, wherein a plurality of latching parts are formed at intervals along the outer periphery of the cylindrical shape of the outer body part, and
each of the blades is configured such that:
an opposite end portion of the blade, which is far from the central axis of the impeller, is latched to the latching part when the gas is introduced into a space between rear surfaces of the blades; and
the opposite end portion of the blade, which is far from the central axis of the impeller, is released from the latching part when the gas is discharged from the space between the rear surfaces of the blades.

11. The power generation apparatus of claim 1, wherein each of the blades has a middle portion having a front surface shape protruding and curved in a rotation direction of the impeller.

12. The power generation apparatus of claim 1, wherein at least two impellers are installed in parallel on one rotary shaft, and
a gas transmission part configured to transmit the gas to an inlet of at least one gas discharge pipe located on the lower side based on a central axis of each of the impellers is provided for each of the impellers.

13. The power generation apparatus of claim 1, wherein the gas discharged through the space between the blades through a plurality of gas discharge regions formed at intervals along an outer periphery of the impeller is discharged to an upper portion of the liquid by the buoyancy.

14. The power generation apparatus of claim 13, wherein each of the blades is configured such that one end portion of the blade, which is close to the central axis of the impeller, is coupled so as to be rotatable about a rotation part, and a rotation angle varies according to whether the gas is introduced into or discharged from a space between rear surfaces of the blades.

15. The power generation apparatus of claim 14, wherein each of the blades is configured such that an opposite end portion of the blade, which is far from the central axis of the impeller, is latched to or released from each of latching parts formed at intervals along the outer periphery of the impeller according to a variation in the rotation angle about the rotation part.
